(19) United States
(12) Patent Application Publication
(10) Pub. No.: US 2016/0062416 A1
(43) Pub. Date: Mar. 3, 2016

(54) HINGE APPARATUS AND ELECTRONIC DEVICE

(71) Applicant: KABUSHIKI KAISHA TOSHIBA, Tokyo (JP)

(72) Inventors: Hiroaki HIRAO, Ome Tokyo (JP); Atsushi TATEMICHI, Ota Tokyo (JP)

(21) Appl. No.: 14/735,895

(22) Filed: Jun. 10, 2015

(30) Foreign Application Priority Data
Aug. 29, 2014 (JP) 2014-176388

(51) Int. Cl. G06F 1/16; E05D 5/06; E05D 3/02

(52) U.S. Cl. CPC G06F 1/1681; G06F 1/1616; E05D 3/02; E05D 5/06

(57) ABSTRACT

According to one embodiment, a hinge apparatus includes a first hinge and a second hinge. The first hinge includes a rotation axis portion and a fastening portion fastened to a first component. The second hinge is fastened to a second component and rotatably connected to the rotation axis portion. The fastening portion includes an arm, a first wall, a second wall. The arm is fixed to and intersecting the rotation axis portion. The first wall is provided with a first mounting portion and projecting from the arm at a position apart from the rotation axis portion in a direction intersecting the arm. The second wall is provided with a second mounting portion and projecting from the arm in a direction intersecting the arm at a position apart from the rotation axis portion and apart from the first wall in a thickness direction.

### CROSS-REFERENCE TO RELATED APPLICATIONS

This application is based upon and claims the benefit of priority from Japanese Patent Application No. 2014-176388, filed Aug. 29, 2014, the entire contents of which are incorporated herein by reference.

### FIELD

Embodiments described herein relate generally to a hinge apparatus and an electronic device.

### BACKGROUND

Conventionally, there has been known a hinge apparatus comprising: a first hinge member comprising a rotation axis portion and a fastening portion fastened to a first component; and a second hinge member fastened to a second component and rotatably connected to the rotation axis portion.

Regarding such a configuration, it is desirable to obtain a hinge apparatus and an electronic device having a new configuration with less inconveniences.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view illustrating an electronic device in an opened state as viewed from the front of the electronic device, according to an embodiment;

FIG. 2 is an exemplary perspective view illustrating the electronic device in the opened state as viewed from the back of the electronic device, in the embodiment;

FIG. 3 is an exemplary plan view illustrating a connector of the electronic device and illustrating a locking position of hooks, in the embodiment;

FIG. 4 is an exemplary plan view illustrating the connector of the electronic device and illustrating an unlocking position of the hooks, in the embodiment;

FIG. 5 is an exemplary exploded perspective view illustrating the connector of the electronic device in the embodiment;

FIG. 6 is an exemplary cross-sectional view taken along a line VI-VI in FIG. 5, in the embodiment;

FIG. 7 is an exemplary perspective view illustrating a hinge apparatus in the embodiment; and

FIG. 8 is an exemplary perspective view illustrating a first member of the hinge apparatus in the embodiment.

### DETAILED DESCRIPTION

In general, according to one embodiment, a hinge apparatus comprises a first hinge and a second hinge. The first hinge comprises a rotation axis portion and a fastening portion fastened to a first component. The second hinge is fastened to a second component and rotatably connected to the rotation axis portion. The fastening portion comprises an arm, a first wall, a second wall. The arm is fixed to and intersecting the rotation axis portion. The first wall is provided with a first mounting portion and projecting from the arm at a position apart from the rotation axis portion in a direction intersecting the arm. The second wall is provided with a second mounting portion and projecting from the arm in a direction intersecting the arm at a position apart from the rotation axis portion and apart from the first wall in a thickness direction.

The following discloses an exemplary embodiment of the present invention. The configurations of the embodiment described below and the operations and results (effects) provided by the configurations are given for illustrative purposes only. The present invention can be implemented by way of configurations other than those disclosed in the embodiment below. The present invention can obtain at least one of various effects (including derivative effects) that can be obtained by the configurations.

Although, in the embodiment described below, a hinge apparatus is installed in, for example, an electronic device, the hinge apparatus according to the embodiment is not limited to this. The hinge apparatus according to the embodiment may be installed in various structures, such as a door, that have rotatable two parts (components). Although, in the embodiment described below, an electronic device is configured as, for example, a personal computer, the electronic device according to the embodiment is not limited to this. The electronic device according to the embodiment may be configured as various kinds of electronic devices such as a smart television, a mobile phone, an electronic dictionary, a video display device, and a videophone.

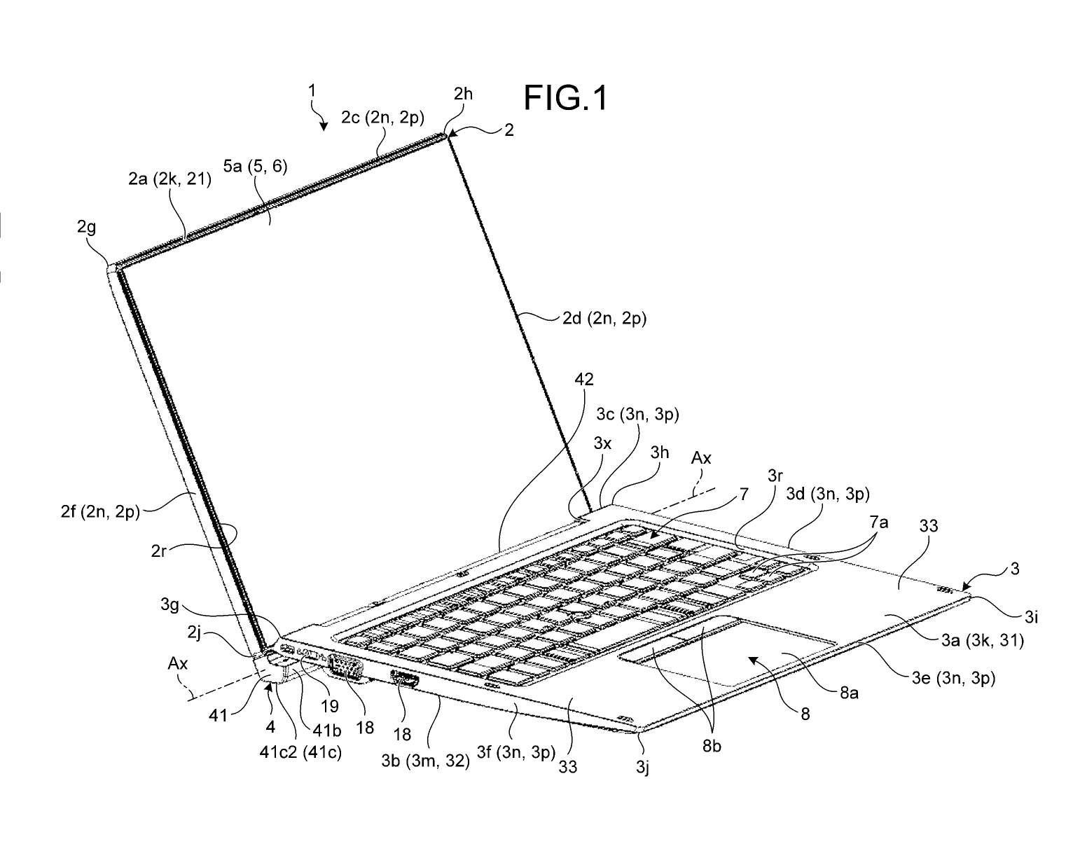

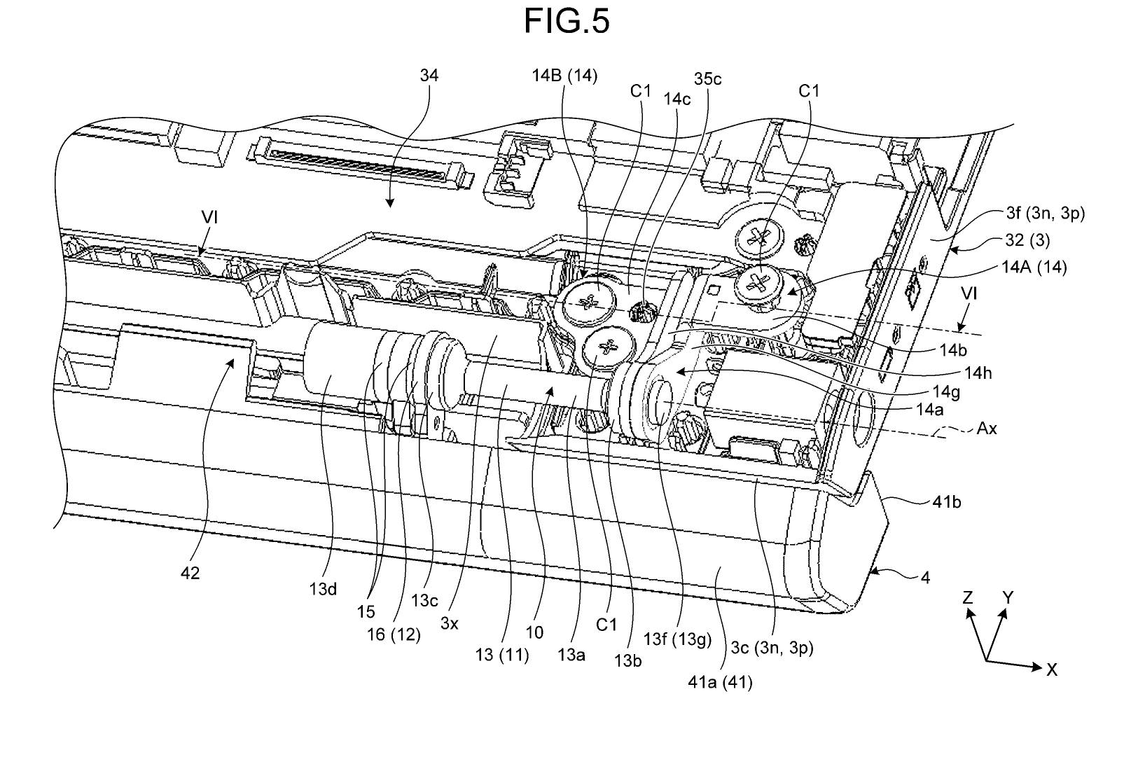

As illustrated in FIGS. 1 to 3, an electronic device 1 comprises, for example, a housing 2 (device, component), a housing 3 (device, component), and a housing 4 (connector, component). The housing 2 comprises, for example, a display device 5 and a touch panel 6. A user can view a video (image) displayed on the display device 5 through the touch panel 6. The housing 2 is, for example, a tablet personal computer. The housing 3 comprises, for example, a key module 7 and an input operation module 8. In the present embodiment, as illustrated in FIG. 5, for example, a hinge 10 (hinge apparatus) is provided between the housing 3 and the housing 4. The housing 4 is connected to the housing 3 via the hinge 10 such that the housing 4 can rotate about a rotation center Ax. The housing 2 can be detachably coupled (connected) to the housing 4 that is connected to the housing 3. In the present embodiment, the housing 3 is an example of a first component and a first housing, and the housing 4 is an example of a second component and a second housing.

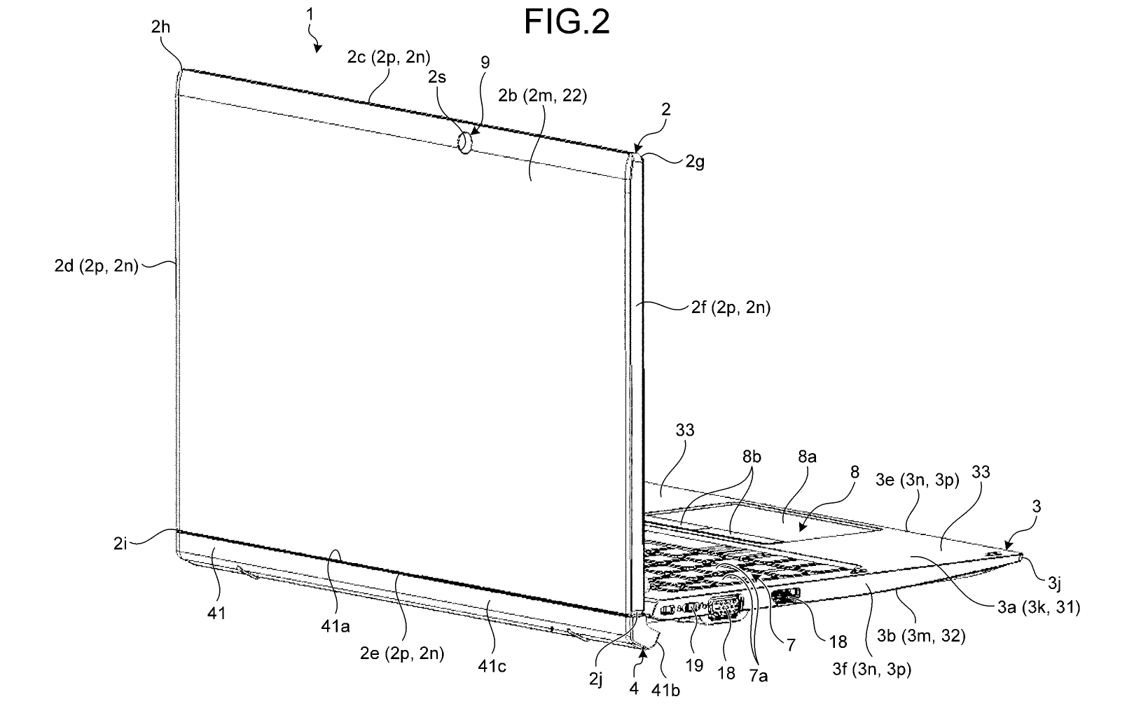

The electronic device 1 can be used, for example, in a tablet mode (not illustrated) in which the housing 2 is not connected to the housing 3, and in a clamshell mode (a notebook mode, see FIGS. 1 and 2) in which the housing 2 is connected to the housing 3. In the clamshell mode, the housing 4 on which the housing 2 is mounted rotates relative to the housing 3, whereby the electronic device 1 is transformable between an opened state (see FIG. 1) in which the housing 2 and the housing 3 are unfolded and a folded state (not illustrated) in which the housing 2 and the housing 3 are folded. In the folded state, the housing 2 and the housing 3 overlap each other in the thickness direction of the housing 2 and the housing 3. In the folded state, the housing 2 and the housing 3 overlap each other with a face 2a of the housing 2 and a face 3a of the housing 3 facing each other, whereby, for example, the display device 5, the touch panel 6, the key module 7, and the input operation module 8 are hidden between the housing 2 and the housing 3. In the opened state, the face 2a of the housing 2 and the face 3a of the housing 3 are exposed, whereby the user can use (view or operate), for example, the display device 5, the touch panel 6, the key module 7, and the input operation module 8.

In the clamshell mode, electrical components (for example, a circuit board) stored in the housing 2 are electrically connected to electrical components (for example, the key module 7 and the input operation module 8) stored in the housing 3 via conductors such as connectors, harnesses, and flexible printed circuits (not illustrated). In the clamshell mode, the housing 3 expands the function of the housing 2. In other words, the housing 3 is an example of a function expansion device (cradle, dock, docking station). The data obtained by an input operation on, for example, the key module 7 or the input operation module 8 may be input to the circuit board of the housing 2 via a wireless communication mechanism (such as a transmission and reception circuit and an antenna).

As illustrated in FIGS. 1 and 2, the housing 2 is configured in a quadrangular shape (for example, a rectangular shape) as viewed from the front and the back of the housing 2. The housing 2 is configured in a thin, flat rectangular solid shape in the fore and aft direction (the thickness direction) of the housing 2. The housing 2 comprises the face 2a (front, front face, surface, face portion) and a face 2b (back face, rear face, underside face, face portion) positioned opposite to the face 2a. The faces 2a and 2b are substantially parallel to each other. The housing 2 comprises four ends 2c to 2f (sides, edges) and four corners 2g to 2j (protruding portions, rounded portions, ends) as viewed from the front and the back of the housing 2.

The housing 2 comprises, for example, a wall 2k (part, plate, frame, front wall, surface wall, top wall) having the face 2a, and a wall 2m (part, plate, rear wall, back wall, bottom wall) having the face 2b. The walls 2k and 2m have a quadrangular shape (for example, a rectangular shape). The housing 2 comprises four walls 2n (parts, plates, side walls, end walls, standing walls, extending portions) having faces 2p (side faces, circumferential faces) extending between the walls 2k and 2m. The wall 2k is provided with, for example, an opening 2r having a quadrangular shape. Thus, the wall 2k is formed in a frame-like quadrangular shape.

The housing 2 may be configured by combining, for example, a plurality of components (divided bodies). Specifically, the housing 2 comprises, for example, a first housing member 21 (first part, front member, mask, mask portion, cover, front cover, cover portion, first area) having at least the wall 2k, and a second housing member 22 (second part, rear member, base, base portion, bottom, bottom portion, cover, rear cover, cover portion, second area) having at least the wall 2m. The walls 2n are comprised in at least one of the first housing member 21 and the second housing member 22 (for example, in the second housing member 22). The housing 2 may be composed of, for example, metal or synthetic resin material.

The housing 2 stores at least a portion of the display device 5. The display device 5 comprises a display screen 5a. The display screen 5a is positioned on the face 2a of the housing 2, and is exposed to the front (outside) of the housing 2 via the opening 2r. The User can view the display screen 5a through the opening 2r from the front of the housing 2. The display device 5 is configured in a quadrangular shape (for example, a rectangular shape) as viewed from the front of the display device 5. The display device 5 is configured in a thin, flat rectangular solid shape in the fore and aft direction (thickness direction of the housing 2) of the display device 5. The display device 5 is, for example, a liquid crystal display (LCD) or an organic electro-luminescent display (OELD).

In the present embodiment, for example, the touch panel 6 (touch sensor, input operation panel, operating surface, cover) is provided on the front side of the display device 5 (on the face 2a of the housing 2). The touch panel 6 is configured in a transparent, relatively thin quadrangular shape, and covers the display screen 5a. The user can execute input processing by performing operations such as tapping, pressing, and flicking on the touch panel 6 by a finger or with a component (for example, a stylus), or by moving, for example, a finger or a stylus near the touch panel 6. Light emitted from the display screen 5a of the display device 5 passes through the touch panel 6, and is output from the opening 2r of the wall 2k to the front (outside) of the housing 2.

In the present embodiment, for example, a camera module 9 (camera unit, camera assembly, camera, image-capturing device) is stored in the housing 2 at the rear side (underside, back side, a side at which the wall 2m is positioned, opposite side to the display screen 5a) of the display device 5. The camera module 9 is exposed through an opening 2s provided on the wall 2m. In addition to the camera module 9, other electrical components may be provided in the housing 2. The electrical components are, for example, a circuit board (wiring board, printed wiring board, control board), wiring (such as cables, harnesses, flexible cables, and flexible printed circuits), a battery module (battery, assembled battery, cell, module, battery package, battery unit), a speaker module (speaker unit, speaker assembly, speaker, audio output device), and an antenna module (antenna unit, antenna assembly, antenna, first transmission and reception module). These electrical components may be electrically connected to each other via wiring.

As illustrated in FIGS. 1 and 2, the housing 3 is configured in a quadrangular shape (for example, a rectangular shape) as viewed from the front and the back of the housing 3. The housing 3 is configured in a thin, flat rectangular solid shape in the top and bottom direction (the thickness direction of the housing 3). The housing 3 comprises the face 3a (front, top face, surface, face portion) and a face 3b (back face, bottom face, underside face, face portion) positioned opposite the face 3a. The faces 3a and 3b are substantially parallel to each other. The housing 3 comprises four ends 3c to 3f (sides, edges) and four corners 3g to 3j (protruding portions, rounded portions, ends) as viewed from the front and the back of the housing 3.

The housing 3 comprises, for example, a wall 3k (part, plate, frame, front wall, surface wall, top wall) having the face 3a, and a wall 3m (part, plate, rear wall, back wall, bottom wall) having the face 3b. The walls 3k and 3m have a quadrangular shape (for example, a rectangular shape). The housing 3 comprises four walls 3n (parts, plates, side walls, end walls, standing walls, extending portions) having face 3p (side faces, circumferential faces) extending between the walls 3k and 3m. The wall 3k is provided with, for example, an opening 3r having a quadrangular shape. Thus, the wall 3k is formed in a frame-like quadrangular shape.

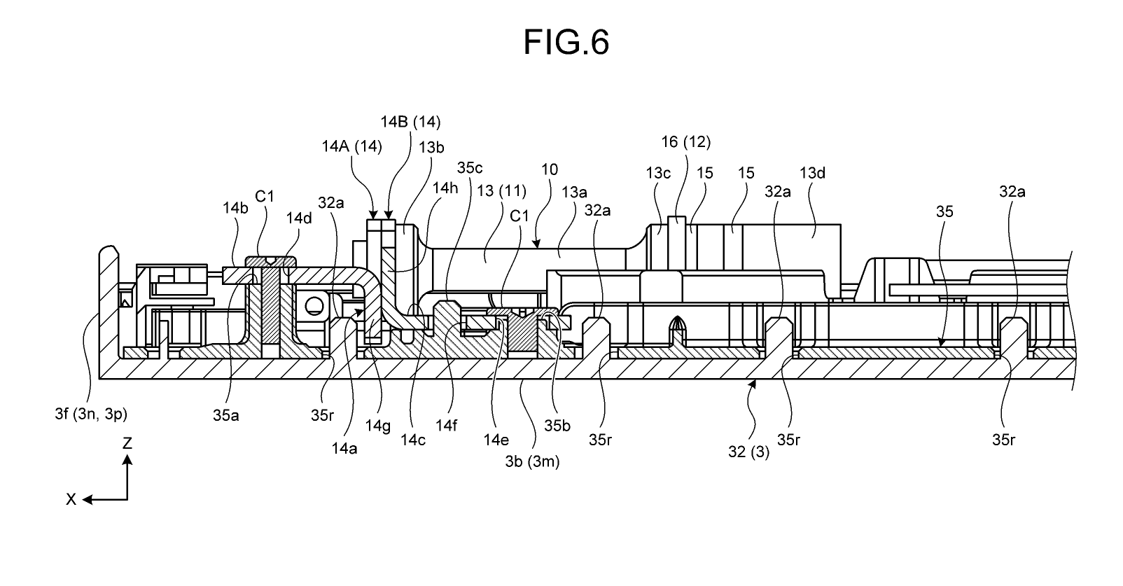

The housing 3 may be configured by combining, for example, a plurality of components (divided bodies). Specifically, the housing 3 comprises, for example, a first housing member 31 (first part, front member, mask, mask portion, cover, front cover, cover portion, first area) having at least the wall 3k, and a second housing member 32 (second part, rear member, base, base portion, bottom, bottom portion, cover, rear cover, cover portion, second area) having at least the wall 3m. The walls 3n are comprised in at least one of the first housing member 31 and the second housing member 32 (for example, in the second housing member 32). In addition to the first housing member 31 and the second housing member 32, the housing 3 may comprise, for example, a third housing member 35 (third part, intermediate member, isolating member, barrier wall member, wall member, interposition member, inner plate, middle plate, middle frame, shield, third area, see FIG. 6) positioned between the first housing member 31 and the second housing member 32. The third housing member 35 is configured in a flat board-like shape along the wall 3m. The third housing member 35 is provided with a plurality of openings 35r along the end 3c. In the present embodiment, for example, protrusions 32a of the second housing member 32 are inserted into the openings 35r, whereby the position of the third housing member 35 may be determined in the projecting direction (thickness direction of the housing 3, Z direction in FIG. 6) of the protrusions 32a, and in the direction (for example, the orthogonal direction) intersecting with the projecting direction. The housing 3 may be composed of, for example, metal or synthetic resin material.

The housing 3 stores at least a portion of the key module 7 (key unit, keyboard module, keyboard unit). The key module 7 comprises a plurality of keys 7a (operating module). The keys 7a are supported by a supporting member (not illustrated) such that the keys 7a can move inwards and outwards (can move upwards and downwards, can be displaced). The keys 7a are exposed to the front (outside) of the housing 3 through the opening 3r. In the present embodiment, for example, the key module 7 is positioned close to the end 3c of the face 3a, and the input operation module 8 is positioned close to the end 3e (opposite to the end 3c) of the face 3a.

The input operation module 8 comprises, for example, a pointing device 8a (touch pad, touch panel) having a quadrangular shape (for example, a rectangle shape) and positioned at a side at which the end 3e is positioned, and click buttons 8b (buttons) each having a quadrangular shape (for example, a rectangular shape) and positioned at a side at which the opening 3r is positioned (at a side at which the key module 7 is positioned). In the present embodiment, a plurality of (for example, two) click buttons 8b are provided along the end 3e. Palm rests 33 (placement portions) are provided on both sides of the input operation module 8 on the wall 3k (on both sides of the direction along the end 3e). The palm rests 33 are portions on which the user puts the hands, and configured in a flat surface (board-like shape).

In the present embodiment, for example, the housing 3 stores one or more wiring boards 34 (circuit board, control board, printed wiring board, see FIG. 5) at the rear side (underside, back side, on a side at which the wall 3m is positioned) of the key module 7. The wiring boards 34 are provided substantially parallel to the key module 7. The wiring boards 34 are provided at a position apart from the walls 3k, 3m, and 3n, that is, provided such that space (gap) is left between the wiring boards 34 and the walls 3k, 3m, and 3n. On the wiring boards 34, for example, a plurality of components (not illustrated) can be installed such as a central processing unit (CPU), a graphics controller, a power circuit component, a platform controller hub, a memory slot connector, a LCD connector, an input/output (I/O) connector, a power coil, elements, and connectors. The control circuit may contain, for example, a video signal processor, a tuner, a high-definition multimedia interface (HDMI) (registered trademark) signal processor, an audio video (AV) input terminal, a remote control signal reception module, a control module, a selector, an on-screen display interface, a storage module (such as a read only memory [ROM], a random access memory [RAM], a hard disk drive [HDD], and a solid state drive [SSD]), and an audio signal processor.

In the present embodiment, for example, other electrical components may be provided in the housing 3 in addition to the wiring boards 34. The electrical components are, for example, a battery module (battery, assembled battery, cell, module, battery package, battery unit), a speaker module (speaker unit, speaker assembly, speaker, audio output device), an antenna module (antenna unit, antenna assembly, antenna, second transmission and reception module), and wiring (such as cables, harnesses, flexible cables, and flexible printed circuits). These electrical components may be electrically connected to each other via wiring.

In the present embodiment, for example, connectors 18 and an operating module 19 are provided on a face 3p. The connectors 18 are, for example, a connector for a power cable, a universal serial bus (USB) connector, a card connector, and connectors for earphones and a microphone. The operating module 19 is, for example, a slide switch, a push button, a push switch, a pointing device, or a dial.

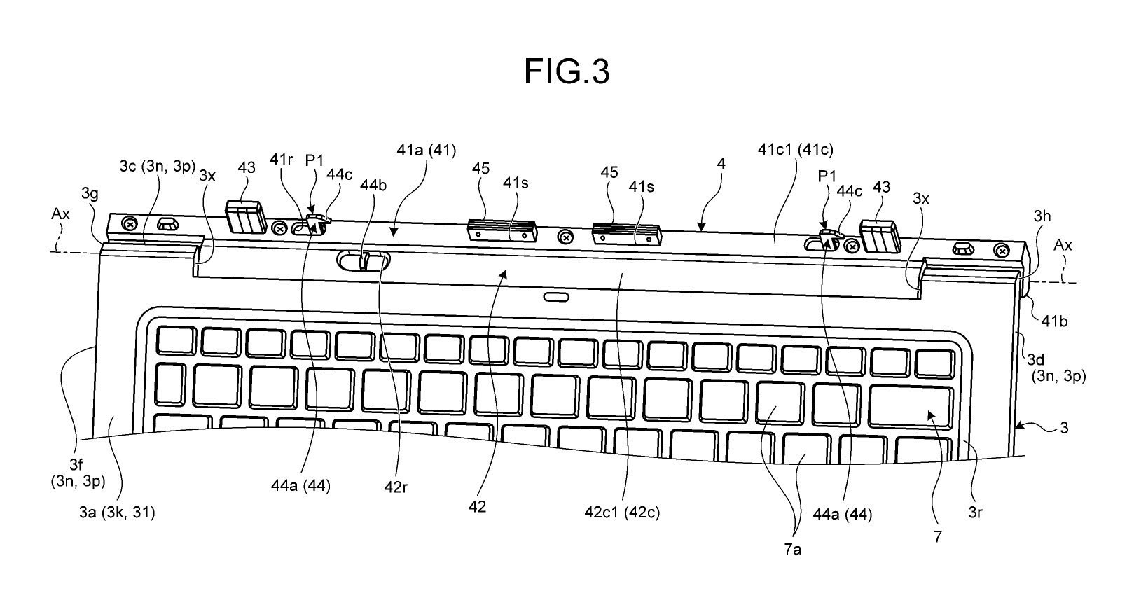

In the present embodiment, for example, a recess 3x (opening, groove, recessed groove, cut-out portion, storage portion) is provided on the end 3c of the housing 3. The recess 3x is configured in a cut-out shape open to the opposite side to the end 3e. The recess 3x is positioned substantially in the middle of the end 3c, and extends long and thin along the end 3c. In the present embodiment, for example, the length of the recess 3x in the direction along the end 3c is slightly shorter than the length of the opening 3r (key module 7) in the direction along the end 3c. As illustrated in FIG. 3, at least a portion (second portion 42) of the housing 4 is inserted into the recess 3x.

As illustrated in FIG. 1, the housing 4 comprises, for example, a first portion 41 and the second portion 42. The first portion 41 is connected to either one of the housing 2 and the housing 3 (for example, the housing 2), and the second portion 42 is connected to other one of the housing 2 and the housing 3 (for example, the housing 3). The first portion 41 is positioned at the outside of the recess 3x and extends long and thin from the end 3d to the end 3f of the housing 3. As illustrated in FIGS. 1 and 2, the first portion 41 is configured in a substantial V-shape (substantial U-shape) as viewed in the direction along the end 3c (rotation center Ax). In the present embodiment, the housing 2 is joined (connected) to either (for example, an end 41a) of two ends 41a and 41b (top ends) of the substantial V-shape. As illustrated in FIG. 2, the end 41a extends along the end 2e of the housing 2. As illustrated in FIG. 3, for example, protrusions 43 to be connected to the housing 2, hooks 44a (locking member 44), and connectors 45 are provided on the end 41a.

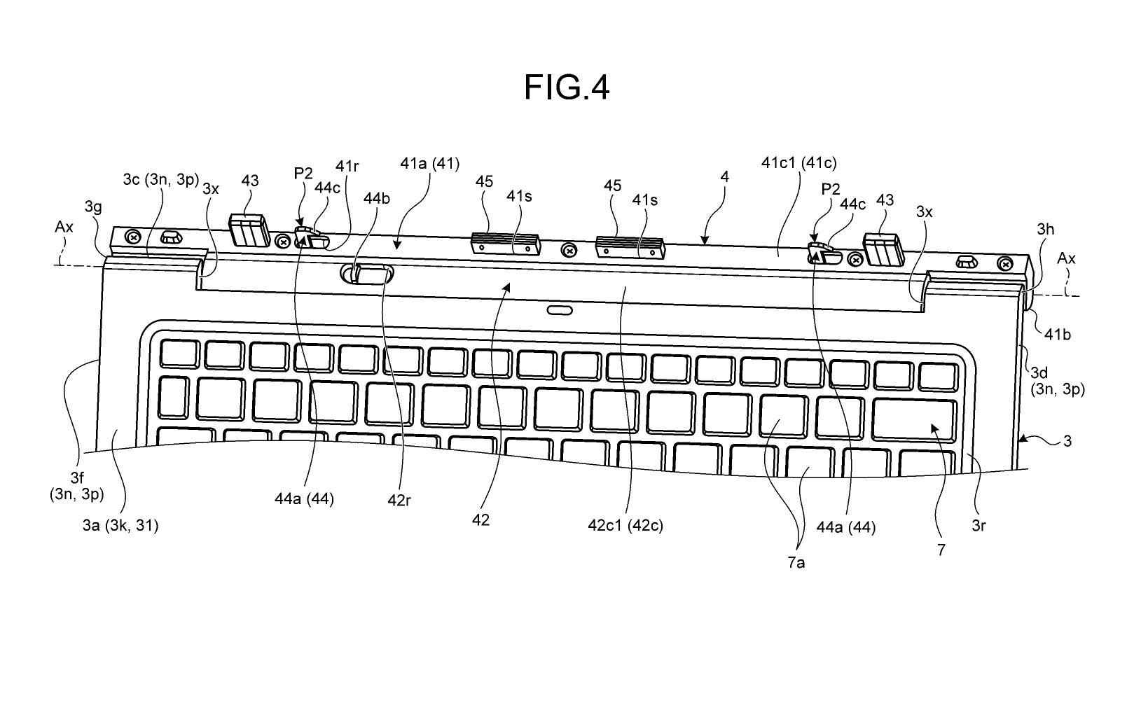

The first portion 41 comprises a plurality of walls 41c (outer walls, parts, plates, frames). The walls 41c comprise, for example, a wall 41c1 (see FIGS. 3 and 4) constituting the end 41a described above, and a wall 41c2 (see FIG. 1) positioned apart from the wall 41c1 and placed on a placement surface (not illustrated) when the electric device 1 is used in the clamshell mode. As illustrated in FIG. 1, when the wall 41c2 is placed on the placement surface in the clamshell mode, the end 3c of the housing 3 is separated from the placement surface, and the end 3e of the housing 3 contacts the placement surface. In other words, the housing 3 inclines relative to the placement surface. This configuration, for example, may help the user operate the key module 7 (keys 7a) more easily than in a case in which the housing 3 is placed parallel to the placement surface in the clamshell mode.

As illustrated in FIGS. 3 and 4, the second portion 42 projects from the first portion 41 toward the end 3c of the housing 3, and is stored in the recess 3x. The second portion 42 extends long and thin from one end to the other end of the recess 3x in the longitudinal direction (in the direction along the end 3c) of the recess 3x. The second portion 42 comprises a plurality of walls 42c (outer walls, parts, plates, frames). The walls 42c comprises, for example, a wall 42c1 on which an opening 42r is provided through which an operating module 44b (locking member 44) is exposed. The first portion 41 and the second portion 42 maybe composed of, for example, metal or synthetic resin material. The first portion 41 and the second portion 42 may be configured by, for example, combining a plurality of components (housing members, divided bodies).

In the present embodiment, for example, the protrusions 43, the hooks 44a, and the connectors 45 project from the wall 41c1 of the end 41a. When the housing 2 is mounted on the housing 4, the protrusions 43, the hooks 44a, and the connectors 45 enter into the housing 2 through respective openings (not illustrated) provided on the housing 2. In the housing 2, the protrusions 43 abut the housing 2 or members fixed to the housing 2. This configuration can prevent the housing 2 from moving in the direction (for example, the orthogonal direction) intersecting with the projecting direction (detachable direction of the housing 2) of the protrusions 43. In other words, the protrusions 43 function as a positioner that determines the position of the housing 2 in the direction intersecting with the projecting direction of the protrusions 43. The protrusions 43 can also function as a positioner that determines the position of the housing 2 in the projecting direction (mounting direction of the housing 2) of the protrusions 43. The protrusions 43 can function as a guide that is used when the housing 2 is detached from or attached to the housing 4.

The hooks 44a (hooking portion) project from openings 41r provided on the wall 41c1. The openings 41r extends along the end 41a. The hooks 44a are supported by the housing 4 such that the hooks 44a can move (reciprocate) along the longitudinal direction of the openings 41r (along the end 41a). The operating module 44b (operating element) is exposed on the wall 42c1 through the opening 42r extending along the end 41a. The operating module 44b and the hooks 44a are linked inside the housing 4 and move integrally along the end 41a. Each hook 44a has a claw 44c projecting from a side (the right side in FIG. 3) of the hook 44a in the direction along the end 41a. An elastic member (for example, a coil spring) applies force to the hooks 44a or the operating module 44b, or the both in the direction in which the claw 44c projects. In the present embodiment, for example, the hooks 44a can be moved from a position P1 (see FIG. 3) in which the housing 2 is locked to a position P2 (see FIG. 4) in which the housing 2 is unlocked by moving (sliding) the operating module 44b to a side (the left side in FIG. 3) opposite to the claw 44c. When the housing 2 is mounted on the housing 4, the hooks 44a hook, in the housing 2, the housing 2 or members fixed to the housing 2. This configuration can prevent the housing 2 from being detached off from the housing 4. In other words, the hooks 44a can function as a safety lock for the housing 2. The hooks 44a and the operating module 44b are examples of the constituent elements of the locking member 44.

The connectors 45 project from openings 41s provided on the wall 41c1. The connectors 45 are electrically connected to electrical components (for example, the wiring boards 34) of the housing 3 inside the housing 4 via wiring. When the housing 2 is mounted on the housing 4, the connectors 45 are mechanically and electrically connected to connectors (not illustrated) of the housing 2 inside the housing 2. Various types of data and electric power, for example, can be transmitted and received between the electrical components of the housing 2 and those of the housing 3 by connecting the connectors 45 of the housing 4 and the connectors of the housing 2.

In the present embodiment, as illustrated in FIG. 5, the hinge 10 is provided over the housing 3 and the second portion 42 of the housing 4. The hinge 10 (hinge apparatus) comprises, for example: a hinge member 11 comprising a rotation axis portion 13 and a fastening portion 14; and a hinge member 12 comprising a supporting member 16. The hinge member 11 is fastened (fixed, integrated) to one (for example, the housing 3) of the housing 3 and the housing 4, and the hinge member 12 is fastened (fixed, integrated) to the other one (for example, the housing 4) of the housing 3 and the housing 4. In the present embodiment, the hinge member 11 is an example of a first hinge member, and the hinge member 12 is an example of a second hinge member. In FIG. 5, some components (for example, the protrusions 43, the hooks 44a, and the connectors 45) provided on the first portion 41 are omitted for convenience.

The rotation axis portion 13 (shaft) extends along the end 3c (end 41a). In other words, in the present embodiment, the axial direction (X direction in FIG. 5) of the rotation axis portion 13 is substantially parallel to the direction along the end 3c. The rotation axis portion 13 comprises a relatively thin first portion 13a (small-diameter portion) and second portions 13b, 13c, and 13d (large-diameter portions, flanges) thicker than the first portion 13a. The fastening portion 14 is fixed to (provided such that it cannot rotate about) the rotation axis portion 13, and fastens the rotation axis portion 13 to the housing 3. The supporting portion 16 is fastened to the housing 4, and rotatably supports the rotation axis portion 13 about the rotation center Ax. A plurality of resistance members 15 having a ring-like and belleville spring-like shape surrounding the first portion 13a (small-diameter portion) are sandwiched between the supporting portion 16 and the large-diameter portion 13d. The resistance members 15 apply pressing force (frictional force) to the supporting portion 16 and the large-diameter portion 13d by the elastic force of the resistance members 15. By this configuration, frictional resistance torque (or holding torque for holding a position) is produced when the supporting portion 16 (housing 4) rotates relative to the rotation axis portion 13 (housing 3). In the present embodiment, the housing 3 and the housing 4 are rotatably connected about the rotation center Ax by the hinge 10 described above. Although, in the present embodiment, the hinge 10 is provided on both sides of the second portion 42 of the housing 4 in the axial direction (X direction), the hinge 10 may be provided only on one side of the second portion 42 in the axial direction (X direction).

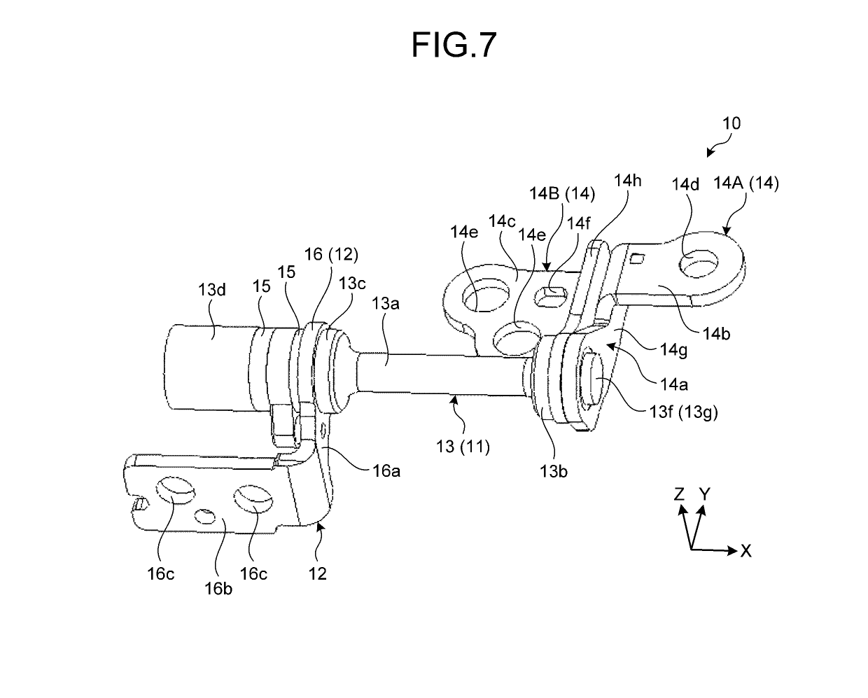

As illustrated in FIG. 7, the supporting portion 16 comprises, for example, an arm 16a and a wall 16b. The arm 16a is provided with an opening (for example, a through hole) into which the rotation axis portion 13 (first portion 13a) is inserted. The arm 16a extends from the rotation axis portion 13 toward the first portion 41 of the housing 4 in the direction (for example, the orthogonal direction) intersecting with the rotation axis portion 13. The wall 16b projects from an end of the arm 16a positioned opposite the rotation axis portion 13 in the direction (for example, the orthogonal direction) intersecting with the arm 16a. In the present embodiment, for example, the longitudinal direction (projecting direction) of the wall 16b is substantially parallel to the axial direction (X direction) of the rotation axis portion 13. The thickness direction of the wall 16b is substantially parallel to the longitudinal direction (extending direction, Y direction) of the arm 16a. The wall 16b is provided with a plurality of mounting portions 16c (for example, through holes). The wall 16b is fastened to the housing 4 by fasteners (not illustrated) such as screws that penetrate the mounting portions 16c.

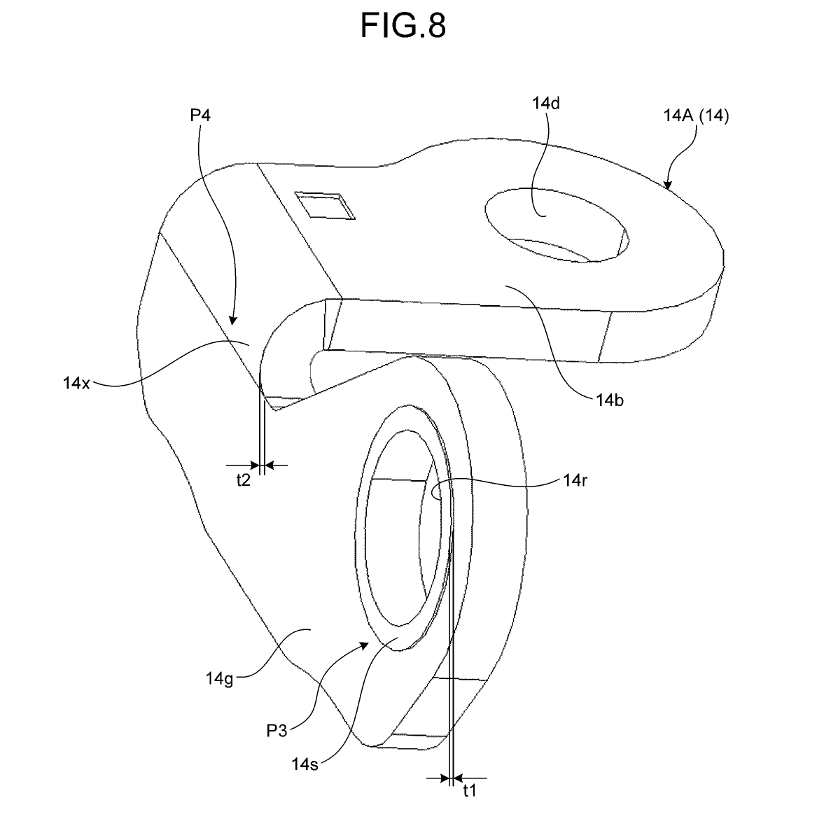

As illustrated in FIG. 7, the fastening portion 14 comprises, for example, an arm 14a, a wall 14b, and a wall 14c. The arm 14a is provided with an opening 14r (see FIG. 8) into which the rotation axis portion 13 (first portion 13a) is inserted. The arm 14a extends from the opening 14r (rotation axis portion 13) toward the end 3e of the housing 3 in the direction (for example, the orthogonal direction) intersecting with the rotation axis portion 13. The wall 14b projects from a side of the arm 14a opposite to the rotation axis portion 13 in the direction (for example, the orthogonal direction) intersecting with the arm 14a. In other words, the wall 14b is positioned apart from the rotation axis portion 13. In the present embodiment, for example, the longitudinal direction (projecting direction) of the wall 14b is substantially parallel to the axial direction (X direction) of the rotation axis portion 13. The thickness direction of the wall 14b is substantially parallel to the width direction (thickness direction of the housing 3, Z direction) of the arm 14a. The wall 14c projects from a side of the arm 14a opposite the rotation axis portion 13 in the direction (for example the orthogonal direction) intersecting with the arm 14a in the same manner as in the case of the wall 14b. In the present embodiment, for example, the wall 14c is provided at one end of the arm 14a at one side (lower side) in the width direction (thickness direction of the walls 14b and 14c, Z direction) of the arm 14a, and the wall 14b is provided at other end of the arm 14a at other side (upper side) in the width direction (Z direction) of the arm 14a. In other words, the wall 14c is positioned apart from the rotation axis portion 13, and apart from the wall 14b in the thickness direction (Z direction) of the wall 14b. The walls 14b and 14c are substantially parallel to each other along the faces 3a and 3b of the housing 3, and are each positioned in a different level in the thickness direction (Z direction) of the housing 3.

As illustrated in FIG. 7, the walls 14b and 14c are provided, respectively, with a mounting portion 14d and mounting portions 14e (for example, through holes) in a form of an opening. As illustrated in FIGS. 5 and 6, a fastener C1 (for example, a screw) inserted into the mounting portion 14d of the wall 14b is fastened (fixed) to a boss 35a (see FIG. 6) of the housing 3 (third housing member 35). Fasteners C1 (for example, screws) inserted into the mounting portions 14e of the wall 14c are fastened (fixed) to bosses 35b (one of which is illustrated in FIG. 6) of the housing 3. The projection height of the boss 35a along the thickness direction (Z direction) of the housing 3 is higher than that of the bosses 35b. In the housing 3, a protrusion 35c is provided adjacent to the bosses 35b. The projection height of the protrusion 35c is higher than that of the bosses 35b, and shorter than that of the boss 35a. The protrusion 35c is inserted into an opening 14f (for example, a through hole) provided adjacent to the mounting portions 14e on the wall 14c. The protrusion 35c can function as a positioner that determines the position of the wall 14c (that is, the fastening portion 14) in the projecting direction (Z direction) of the protrusion 35c, and as a positioner that determines the position of the wall 14c (that is, the fastening portion 14) in the direction (for example, the orthogonal direction, the XY direction) intersecting with the projecting direction of the protrusion 35c.

Although, in the present embodiment, the wall 14b is provided with a single mounting portion 14d and the wall 14c is provided with a plurality of (for example, two) mounting portions 14e, the number of mounting portions 14d and 14e or the layout thereof, for example, are not limited to this. According to the present embodiment, the fastening portion 14 has two walls 14b and 14c. This configuration can support a wider range of the number and the layout of the bosses 35a and 35b that may be provided in the housing 3. Because the fastening portion 14 has two walls 14b and 14c, the mounting portions 14d and 14e can be arranged more freely. Thus, for example, the hinge member 11 can be mounted on the housing 3 more easily via a plurality of mounting portions 14d and 14e, and can be mounted on the housing 3 more tightly. In the present embodiment, the wall 14b is an example of a first wall, and the wall 14c is an example of a second wall. In the present embodiment, the mounting portion 14d is an example of a first mounting portion, and the mounting portions 14e are an example of a second mounting portion.

In the present embodiment, for example, the wall 14b positioned at a side (outer side) of the axial direction (X direction in FIGS. 5 and 6) extends from the arm 14a toward the side (outer side) of the axial direction (X direction), and the wall 14c positioned at the other side (internal side) of the axial direction (X direction in FIGS. 5 and 6) extends from the arm 14a toward the other side (internal side) of the axial direction (X direction). In other words, the walls 14b and 14c extend in opposite directions from the arm 14a. This configuration can further increase rigidity of the hinge 10 with respect to the twisting moment acting on the hinge 10 clockwise and counter clockwise in FIG. 6.

In the present embodiment, for example, the fastening portion 14 is configured by combining a plurality of members (divided bodies, components). Specifically, as illustrated in FIGS. 5 and 7, the fastening portion 14 comprises, for example, a member 14A comprising the wall 14b and a wall 14g constituting the arm 14a, and a member 14B comprising the wall 14c and a wall 14h constituting the arm 14a. The wall 14g of the member 14A and the wall 14h of the member 14B constitute the arm 14a by overlapping each other in the thickness direction (X direction in FIG. 5) of the wall 14g and the wall 14h. The wall 14b is provided at an end of the wall 14g positioned at a side (upper side) in the width direction (width direction of the arm 14a, the Z direction) of the wall 14g, and the wall 14c is provided at an end of the wall 14h positioned at a side (lower side) opposite the side at which the wall 14b is provided in the width direction (width direction of the arm 14a, Z direction) of the wall 14h. In the present embodiment, the wall 14g is an example of a third wall, and the wall 14h is an example of a fourth wall. In the present embodiment, the member 14A is an example of a first member, and the member 14B is an example of a second member.

In the present embodiment, as illustrated in FIG. 6, for example, the wall 14b is bent at one end of the wall 14g positioned at one side (upper side) in the width direction (width direction of the arm 14a, Z direction) of the wall 14g, and is bent in a direction from the wall 14g toward a side (outer side) in the axial direction (X direction). The wall 14c is bent at one end of the wall 14h positioned at other side (lower side) opposite the one side at which the wall 14b is bent in the width direction (width direction of the arm 14a, Z direction) of the wall 14h, and is bent in a direction from the wall 14h toward the other side (inner side) in the axial direction (X direction).

In the present embodiment, as illustrated in FIG. 6, the wall 14c is positioned closer to the wall 3m than the rotation axis portion 13. In other words, the wall 14c is positioned apart from the rotation axis portion 13 at an outer side of the rotation axis portion 13 in the radial direction thereof. Between the walls 14b and 14c of the fastening portion 14, the wall 14c is positioned at the inner side (the side at which the rotation axis portion 13 is positioned) of the axial direction (X direction). Disposed around the rotation axis portion 13 may be, for example, the wiring (harnesses) that electrically connects the electrical components (for example, the connectors 45) of the housing 4 and the electrical components (for example, the wiring boards 34) of the housing 3. According to the present embodiment, for example, more space can be left between the wall 14c and the rotation axis portion 13 for disposing wiring.

In the present embodiment, as illustrated in FIG. 8, for example, the wall 14g is provided with a ridge 14s circularly raised along the opening end (edge) of the opening 14r. A height t1 of the ridge 14s is designed to be substantially the same as a bulging amount t2 of a root portion 14x of the wall 14b that may be formed when the wall 14b is bent. According to the present embodiment, when the walls 14g and 14h are overlapped with each other in the axial direction (X direction) of the rotation axis portion 13, the walls 14g and 14h can contact each other at a position P3 (first position) adjacent to the rotation axis portion 13 and a position P4 (second position) apart from the position P3 in the longitudinal direction (Y direction in FIG. 5) of the arm 14a. According to the present embodiment, for example, this configuration can prevent tilt or unsteadiness of the walls 14g and 14h. The ridge 14s may be composed of a member (for example, a washer) different from the wall 14g or 14h sandwiched between the walls 14g and 14h.

In the present embodiment, for example, the member 14A and the member 14B are integrated by being fixed to the rotation axis portion 13, not by being welded to each other. Specifically, the member 14A and the member 14B are pushed on to an end 13f of the rotation axis portion 13 with the walls 14g and 14h being overlapped with each other, and the end 13f of the rotation axis portion 13 is caulked in this state. The members 14A and 14B are integrated with the rotation axis portion 13 while being sandwiched between the second portion 13b (flange) and a caulking 13g. Consequently, there is no need to consider, for example, welding with respect to the members 14A and 14B, and thus, the members 14A and 14B can be composed of a strong material (for example, plated metal or carbon tool steel [SK material]) that is not suitable for welding. If the members 14A and 14B are welded before being fixed to the rotation axis portion 13, a welding process and a trimming process after the welding process are needed, which may require more time and cost in manufacturing the hinge apparatus. In the present embodiment, on the contrary, less time and cost may be required in manufacturing the hinge apparatus by fixing the members 14A and 14B to the rotation axis portion 13 without welding them.

As described above, in the present embodiment, for example, the fastening portion 14 comprises: the arm 14a fixed to the rotation axis portion 13 and intersecting with the axial direction (X direction) of the rotation axis portion 13; the wall 14b (first wall) provided with the mounting portion 14d (first mounting portion) and projecting from the arm 14a at a position apart from the rotation axis portion 13 in the direction intersecting with the arm 14a; and the wall 14c (second wall) provided with the mounting portions 14e (second mounting portion) and projecting from the arm 14a in the direction intersecting with the arm 14a at a position apart from the rotation axis portion 13 and apart from the wall 14b in the thickness direction (Z direction) of the wall 14b. According to the present embodiment, for example, the two walls 14b and 14c can support a wider range of the number and the layout of the bosses 35a and 35b that may be provided in the housing 3. With the two walls 14b and 14c, for example, the mounting portions 14d and 14e can be arranged more freely. Consequently, for example, the walls 14b and 14c can be arranged more freely, and the hinge member 11 can easily be mounted on the housing 3 by a plurality of walls 14b and 14c, and mounting portions 14d and 14e, whereby the hinge member 11 can be mounted on the housing 3 more tightly. Moreover, for example, the other components of the housing 3 can be arranged more freely. In other words, according to the present embodiment, the hinge 10 (hinge apparatus) and the electronic device 1 having a new configuration with fewer inconveniences can be obtained.

In the present embodiment, for example, the wall 14b (first wall) and the wall 14c (second wall) extend in opposite directions from the arm 14a. According to the present embodiment, for example, the two walls 14b and 14c can be provided near the rotation axis portion 13 compared to a case in which the two walls 14b and 14c project in the same direction from the arm 14a. Consequently, for example, the fastening portion 14 can be configured in a smaller shape in the radial direction of the rotation axis portion 13, that is, the longitudinal direction (Y direction) of the arm 14a.

According to the present embodiment, for example, the fastening portion 14 comprises the member 14A (first member) comprising the wall 14b (first wall) and the wall 14g (third wall) constituting the arm 14a, and the member 14B (second member) comprising the wall 14c (second wall) and the wall 14h (fourth wall) constituting the arm 14a and overlapping the wall 14g in the thickness direction (X direction) of the wall 14g. According to the present embodiment, for example, the shape of the fastening portion 14 can be designed more freely while ensuring a certain level of rigidity and strength of the fastening portion 14 than in a case in which the fastening portion 14 is composed of a single member. Specifically, for example, the walls 14g and 14h (arm 14a) may be configured in a shorter shape in the width direction (Z direction), or in a thinner shape in the thickness direction, or may be disposed closer to the rotation axis portion 13 than in a case in which the fastening portion 14 is composed of a single member.

In the present embodiment, for example, the wall 14b (first wall) is bent at one end of the wall 14g (third wall) positioned at one side in the width direction (Z direction) of the arm 14a, and is bent in a direction from the wall 14g, and the wall 14c (second wall) is bent at one end of the wall 14h (fourth wall) positioned at other side in the width direction (Z direction) of the arm 14a, and is bent in one direction, opposite the direction in which the wall 14b is bent, from the wall 14h.

According to the present embodiment, for example, the difference in the levels at which the walls 14b and 14c are disposed can be wider. This configuration, for example, can leave more space for disposing components (for example, wiring) of the electronic device 1 in some cases.

In the present embodiment, for example, the member 14A (first member) and the member 14B (second member) are integrated by being fixed to the rotation axis portion 13. According to the present embodiment, for example, this configuration can reduce the time and cost in manufacturing the hinge member 11 compared to a case in which the members 14A and 14B are integrated by welding.

In the present embodiment, for example, the wall 14g (third wall) and the wall 14h (fourth wall) contact each other at the position P3 (first position) adjacent to the rotation axis portion 13 and the position P4 (second position) apart from the position P3 in the longitudinal direction (Y direction) of the arm 14a. According to the present embodiment, for example, tilt or unsteadiness of the walls 14g and 14h can be prevented.

In the present embodiment, for example, the wall 14c (second wall) is positioned apart from the rotation axis portion 13 at an outer side of the rotation axis portion 13 in the radial direction thereof. According to the present embodiment, for example, more space can be left between the wall 14c and the rotation axis portion 13 for disposing components (for example, wiring) of the electronic device 1.

The present invention can be implemented by way of configurations other than those disclosed in the embodiment described above, and various effects (including derivative effects) can be obtained by the basic configuration (technical feature) of the present invention. The specifications (such as structure, type, direction, shape, size, length, width, thickness, height, number, disposition, position, and material) of the constituent elements maybe changed as necessary to implement the invention.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A hinge apparatus comprising:
a first hinge comprising a rotation axis portion and a fastening portion fastened to a first component; and
a second hinge fastened to a second component and rotatably connected to the rotation axis portion, wherein
the fastening portion comprises:
an arm fixed to and intersecting the rotation axis portion;
a first wall provided with a first mounting portion and projecting from the arm at a position apart from the rotation axis portion in a direction intersecting the arm; and
a second wall provided with a second mounting portion and projecting from the arm in a direction intersecting the arm at a position apart from the rotation axis portion and apart from the first wall in a thickness direction.

2. The hinge apparatus of claim 1, wherein the first wall and the second wall extend to opposite directions from the arm.

3. The hinge apparatus of claim 1, wherein the fastening portion comprises:
a first member comprising the first wall and a third wall constituting the arm, and
a second member comprising the second wall and a fourth wall constituting the arm, the fourth wall overlapping with the third wall in a thickness direction.

4. The hinge apparatus of claim 3, wherein
the first wall is bent from one side of the arm in a width direction of the arm toward one side from the third wall, and
the second wall is bent from the other side of the arm in the width direction of the arm toward the other side from the fourth wall.

5. The hinge apparatus of claim 3, wherein the first member and the second member are integrated by being fixed to the rotation axis portion.

6. The hinge apparatus of claim 3, wherein the third wall and the fourth wall contact each other at a first position adjacent to the rotation axis portion and at a second position apart from the first position in a direction of the arm extending.

7. The hinge apparatus of claim 1, wherein the second wall is positioned apart from the rotation axis portion at an outer side in a radial direction of the rotation axis portion.

8. An electronic device comprising:
a hinge apparatus of claim 1;
a first housing as the first component; and
a second housing as the second component.
